(19) United States
(12) Patent Application Publication
(10) Pub. No.: US 2018/0170605 A1
(43) Pub. Date: Jun. 21, 2018

(54) COMPOSITION CONTAINER WITH A BRACKET INTERFACING PROTRUSION

(71) Applicant: Henkel IP & Holding GmbH, Duesseldorf (DE)

(72) Inventor: Gregory Schriner, Phoenix, AZ (US)

(73) Assignee: Henkel IP & Holding GmbH, Duesseldorf (DE)

(21) Appl. No.: 15/383,367

(22) Filed: Dec. 19, 2016

(51) Int. Cl. B65D 1/02; B65D 1/42; F16M 13/02; B05B 11/00

(52) U.S. Cl. CPC B65D 1/0261; B65D 1/0246; B05B 11/30; F16M 13/02; B05B 11/0037; B65D 1/42

(57) ABSTRACT

A composition container is described. The composition container includes a reservoir to contain the composition. The container also includes a protrusion extending from a surface of the reservoir. The protrusion interfaces with a retaining bracket. The protrusion includes a number of vertical ribs that extend from a surface of the protrusion and a number of horizontal rinks that extend from the surface of the protrusion.

### FIELD OF THE INVENTION

The present invention generally relates to a composition container, and more particularly relates to a composition container that includes a protrusion that interfaces with a retaining bracket to couple the composition container to a structure to which the retaining bracket is affixed.

### BACKGROUND OF THE INVENTION

A composition container is used to hold a composition for use by a user. Various types of compositions can be disposed within a particular container. Examples of such compositions include personal care compositions such as soaps, lotions, disinfectants, hair sprays, deodorants and/or antiperspirant sprays, perfumes, colognes, and bug sprays. Other types of hair care products, skin care products or personal care products can also be disposed within a container. These are just a few examples, and any number of compositions, both personal care compositions and non-personal care compositions can be disposed within a composition container. The breadth of examples indicates the wide use of compositions, and containers for those compositions in modern society. Accordingly, a composition container that provides additional and unique benefit may be desirable for the additional consumer advantages it provides.

Some containers are positioned within brackets to retain them in place. For example, rather than having a movable container, it may be preferable to couple the composition container to a fixed location. One such example is on an airplane, where turbulence and the normal operations of the airplane may cause a movable container to move about on a surface, which movement could lead to breakage of the composition container, a spilling of the composition, or in some cases, personal injury.

Accordingly, it is desirable to have a composition container that accommodates different compositions disposed therein as well as providing additional consumer advantages. It is further desirable to provide a composition container that provides simple, effective, and user-friendly attachment to a retaining bracket. Furthermore, other desirable features and characteristics of the present invention will become apparent from the subsequent detailed description of the invention and the appended claims, taken in conjunction with the accompanying drawings and this background of the invention.

### BRIEF SUMMARY OF THE INVENTION

A composition container is described. The composition container includes a reservoir to contain a composition. The container also includes a protrusion extending from a surface of the reservoir to interface with a retaining bracket. The protrusion includes a number of vertical ribs extending from a surface of the protrusion and a number of horizontal rings extending from the surface of the protrusion.

The present application also describes a composition containing system. The composition containing system includes a reservoir to contain the composition and a bracket interface to retain the reservoir in a threaded retaining bracket. The bracket interface has at least one horizontal ring and multiple vertical ribs to frictionally couple the reservoir to the threaded retaining bracket.

The present application also describes a composition container that includes a reservoir to contain a composition and a dispensing device to dispense the composition from the reservoir onto an application surface. A protrusion extends from a surface of the reservoir to interface with, and retain the composition container to, a threaded retaining bracket. The protrusion includes a number of radially-disposed vertical ribs and a number of circumferential rings extending from a surface of the protrusion to engage with threads of the threaded retaining bracket to secure the composition container to the threaded retaining bracket.

### BRIEF DESCRIPTION OF THE DRAWINGS

The present invention will hereinafter be described in conjunction with the following drawing figures, wherein like numerals denote like elements, and

FIG. 1 is an isometric diagram of a composition container with a bracket interfacing protrusion, according to an example of the principles described herein.

FIG. 2 is a front diagram of the composition container with the bracket interfacing protrusion, according to an example of the principles described herein.

FIG. 3 is a cross-sectional diagram of the composition container with the bracket interfacing protrusion, according to an example of the principles described herein.

FIG. 4 is a bottom cross-sectional diagram of the bracket interfacing protrusion, according to an example of the principles described herein.

FIG. 5 is a front diagram of the composition container with the bracket interfacing protrusion and a dispensing device, according to an example of the principles described herein.

FIGS. 6A-6C are cross-sectional views of the insertion of the bracket interfacing protrusion into a retaining bracket, according to an example of the principles described herein.

### DETAILED DESCRIPTION OF THE INVENTION

The following detailed description of the invention is merely exemplary in nature and is not intended to limit the invention or the application and uses of the invention. Furthermore, there is no intention to be bound by any theory presented in the preceding background of the invention or the following detailed description of the invention.

As described above, a wide variety of compositions, such as personal care compositions and others compositions are used in society. In some cases, the composition containers are used in environments where a mobile composition container is less than ideal. For example, during flight, airplanes are subject to turbulence which cause objects within the airplane, such as mobile composition containers to shift. Moreover, during landing and take-off, the airplane is again subject to various forces which would cause the composition container to shift within an airplane lavatory. The movement of the composition container in this example, presents any number of complications. For example, the composition container may fall off the countertop surface onto the ground, spilling the contents (on the ground or an occupant), and/or breaking the composition container rendering it ineffective at containing a particular composition. In some extreme cases, the movement of the composition container could cause injury, for example, by striking an occupant.

To alleviate these and other concerns, a composition container of the present application includes a bracket interfacing protrusion. The protrusion includes vertical ribs and horizontal rings. The material of the protrusion, ribs, and rings is soft such that it deforms and conforms to threading within the retaining bracket. This creates a friction fit and as the composition container is twisted, the horizontal rings and vertical ribs engage with the threads and allow the composition container to be screwed into the bracket. When the composition container reaches the end of the threading in the bracket, it can still be rotated via user manipulation. Such a system allows for efficient retention of the composition container in the retaining bracket and allows for an infinite number of alignment positions.

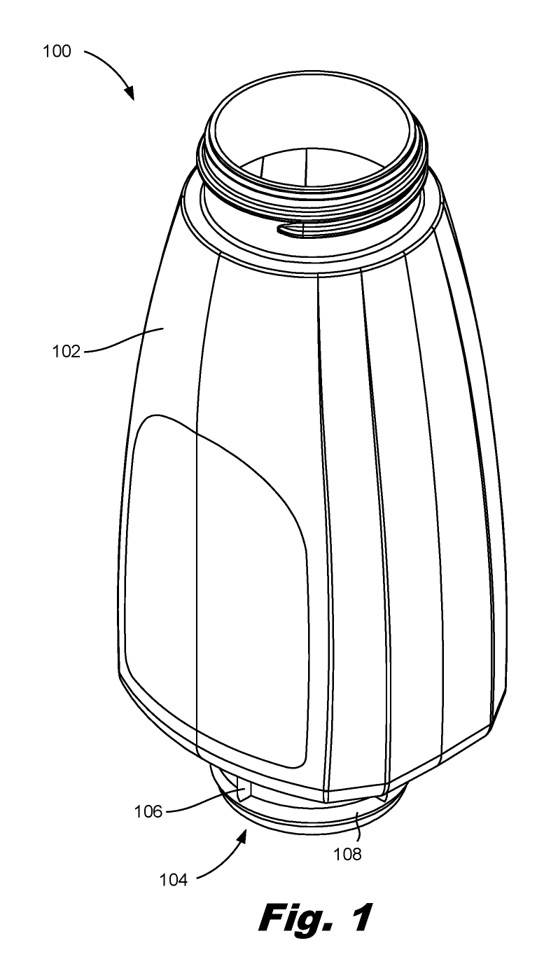

Turning now to the figures, FIG. 1 is an isometric diagram of a composition container (100) with a bracket interfacing protrusion (104), according to an example of the principles described herein. The composition container (100) includes a reservoir (102) to hold a volume of composition. The reservoir (102) may be made of any material including plastic, aluminum, or a composite, among other types of reservoir (102) material. In other words, the reservoir (102) is made of any material that can retain a volume of the composition disposed therein. Examples of compositions that may be disposed within the reservoir (102) include lotions, soaps, disinfecting compositions, and antibacterial compositions, among others. The composition (314) may take many forms. For example, the composition (314) may be a fluid, a gel, an emulsion, a foam, or a foaming gel. While specific examples are provided of specific compositions disposed within the reservoir (102), any number of compositions of any form that are to be applied to a surface may be disposed therein.

The composition container (100) also includes a protrusion (104) that extends from a surface of the reservoir (102) to interface with a retaining bracket. In this example, the protrusion (104) extends below the reservoir (102), i.e., it extends from a bottom surface of the reservoir (102). The protrusion (104) may be any shape including a cylinder as depicted in FIG. 1 and other figures. The protrusion (104) is to be inserted, and received by, a retaining bracket. To couple the composition container (100) to the retaining bracket, the protrusion (104) includes a number of vertical ribs (106) extending from a surface of the protrusion (104) and a number of horizontal rings (108) also extending from the surface of the protrusion (104). In other words, the protrusion (104) may be a non-threaded protrusion (104). That is, it may be free of a helical threading. In use, the horizontal rings (108) and vertical tabs (106) interfere with the retaining bracket, for example with threading on the retaining bracket. As a torsional force is applied to the composition container (100) towards the retaining bracket, the horizontal rings (108) and vertical tabs (106) engage and follow the threads as the composition container (100) is screwed into the retaining bracket.

In some examples, this engagement of the vertical ribs (106) and horizontal rings (108) is facilitated by the protrusion (104), vertical tabs (106), and horizontal rings (108) being formed of a material that is softer than the retaining bracket. For example, the protrusion (104), vertical tabs (106), and horizontal rings (108) may be hollow and/or formed of a soft plastic whereas the retaining bracket may be formed of metal or a hard plastic.

In this case, the soft vertical tabs (106) and horizontal rings (108) deform and conform to the threading on the retaining bracket. Accordingly, as a torsional force is applied, the movement of the composition container (100) is defined by the horizontal rings (108) travelling through the path defined by the threading on the retaining bracket. However, by not fully engaging with the threading, i.e., as the composition container (100) does not include threading that fully engages with the threading on the retaining bracket, the composition container (100) can still rotate after passing by the threading. In other words, at the termination of the threading, the composition container (100) can still rotate; but there is sufficient resistance to keep the composition container (100) in place relative to the retaining bracket.

This rotation afforded by the horizontal rings (108) and vertical tabs (106) allows for infinite alignment possibilities of the composition container (100) relative to the retaining bracket, and more generally relative to the surface to which the retaining bracket is affixed. For example, were a composition container (100) to include threads on the protrusion (104), there would be no guarantee that when fully-seated, i.e., after full engagement of the threads on the protrusion (104) and the threads on the retaining bracket, that the dispensing device would align such that a user could easily dispense of the contents of the composition container (100). However, with the raised surfaces of the horizontal rings (108) and the vertical tabs (106), a friction fit is facilitated that allows the composition container (100) to engage with the threads and be appropriately retained in the bracket. But when the composition container (100) bottoms out on the retaining bracket, the composition container (100) can still be oriented such that a pump or other dispensing device faces the user. This also serves an aesthetic purpose. For example, the composition container (100) may be asymmetric and the infinite alignment possibilities afforded by the bracket interface, i.e., the vertical ribs (106) and horizontal rings (108), allows for any desired alignment of the asymmetrical composition container (100). To this point, while FIG. 1 depicts a particular shape of the composition container (100), any shape could be used.

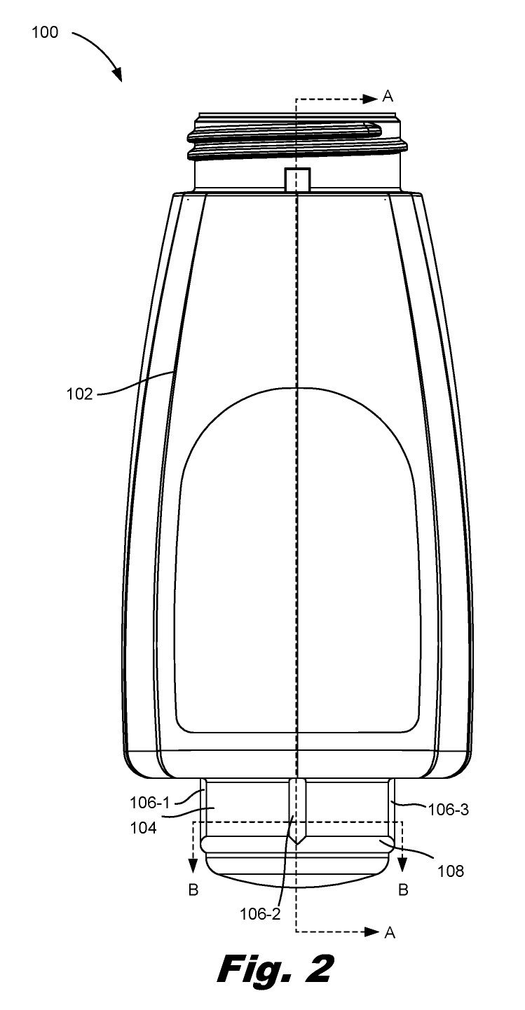

FIG. 2 is a front diagram of the composition container (100) with the bracket interfacing protrusion (104), according to an example of the principles described herein. As described above, in some examples the protrusion (104) extends below the reservoir (102) and the bracket interface may be disposed thereon. As used in the present specification, the bracket interface refers to a component of the composition container (100) that retains the reservoir (102) in a retaining bracket such as a threaded retaining bracket. The bracket interface allows the composition container (100) to be rigidly disposed within the retaining bracket via a friction fit of the vertical ribs (106) and horizontal ring (108) into the threaded retaining bracket.

The bracket interface includes the horizontal ring (108) and vertical ribs (106-1, 106-2, 106-3) to frictionally couple the reservoir (102) to the threaded retaining bracket. As depicted in FIG. 2, the vertical ribs (106-1, 106-2, 106-3) are radially disposed around the protrusion (104) and the horizontal ring (108) is circumferential around the protrusion (104). Note that while FIG. 2 depicts three vertical ribs (106-1, 106-2, 106-3) and one horizontal ring (108), any number of these components may be implemented in accordance with the present specification. The number of horizontal rings (108) and vertical ribs (106) may be selected based on the application. For example, a more secure fit may be facilitated with more of either component. As described above, the bracket interface allows for retention of the composition container (100) within the retaining bracket while still allowing the composition container (100) to be aligned independent of the threading on the retaining bracket.

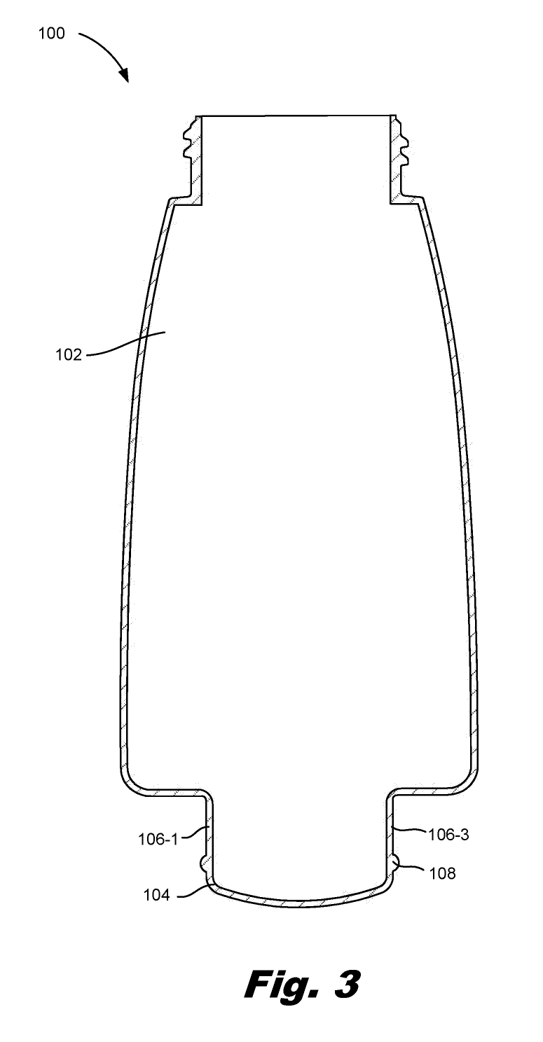

FIG. 3 is a cross-sectional diagram of the composition container (100) with the bracket interfacing protrusion (104), according to an example of the principles described herein. Specifically, FIG. 3 is a cross-sectional diagram of the composition container (100) taken along the line “A-A” from FIG. 2. As can be seen in FIG. 3, the reservoir (102) can hold a volume of the composition, whatever that composition may be. In some examples, for example as depicted in FIG. 3, the protrusion (104) may be hollow and in fluid communication with the reservoir (102). In this example, the protrusion (104) provides additional volume in which the composition may be stored. A hollow protrusion (104) facilitates the deformation that allows the composition container (100) to fit within the retaining bracket. That is, the walls of the protrusion (104) may deflect inward against the pressure of the threading in the retaining bracket, which deflection creates the friction that retains the composition container (100) in position.

In other examples, the protrusion (104) may be solid. In this case, the material of the protrusion (104) is soft enough so as to allow deflection of the protrusion (104) against the pressure exerted by the threads of the retaining bracket against the vertical ribs (106-1, 106-3) and horizontal rings (108). In either case, i.e., solid protrusion and hollow protrusion, the material of the protrusion (104) may be sufficiently soft so as to allow deflection of the vertical ribs (106) and horizontal rings (108) against the threading of the retaining bracket, thus creating a friction fit that allows the composition container (100) to remain within the retaining bracket. Examples of soft materials include plastic materials.

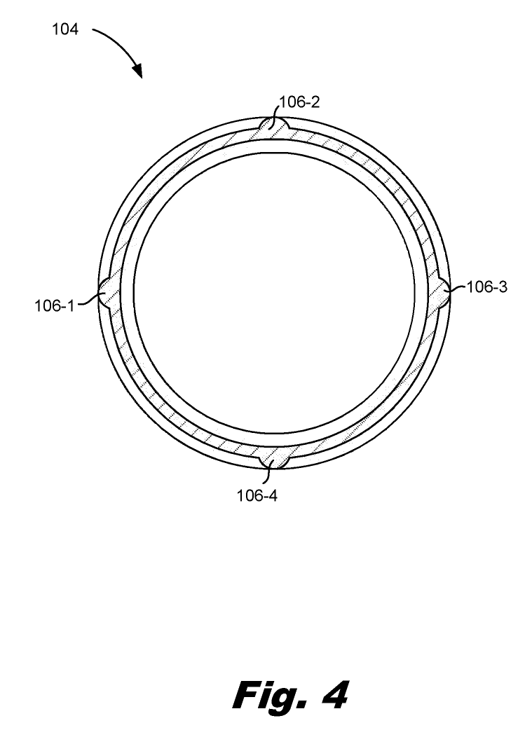

FIG. 4 is a bottom cross-sectional diagram of the bracket interfacing protrusion (104), according to an example of the principles described herein. Specifically, FIG. 4 is a cross-sectional diagram of the composition container (FIG. 1, 100) taken along the line “B-B” from FIG. 2. As can be seen in FIG. 4, the vertical ribs (106-1, 106-2, 106-3, 106-4) may be radially spaced about the protrusion (104). While FIG. 4 depicts four ribs (106-1, 106-2, 106-3, 106-4), any number of ribs (106-1, 106-2, 106-3, 106-4) may be used to instill different characteristics on the coupling between the composition container (FIG. 1, 100) and the retaining bracket. For instance, more ribs (106) and horizontal rings (FIG. 1, 108) may result in a tighter fit. The number of ribs (106) and rings (FIG. 1, 108) may be dependent upon the application.

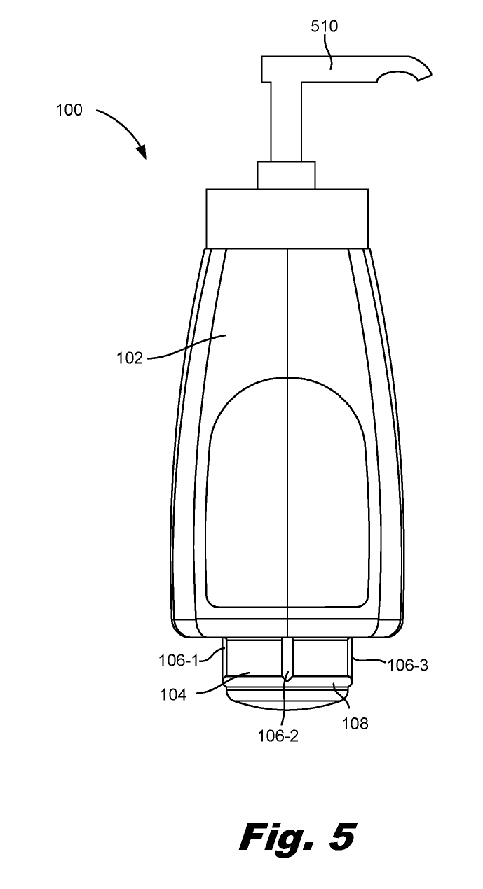

FIG. 5 is a front diagram of the composition container (100) with the bracket interfacing protrusion (104) and a dispensing device (510), according to an example of the principles described herein. As described above, the composition container (100) includes a reservoir (102) and a protrusion (104) that includes bracket interface components that include a number of vertical ribs (106-1, 106-2, 106-3) and a number of horizontal rings (108). The composition container (100) may also include a dispensing device (510) to facilitate the ejection of the composition from the reservoir (102).

In one example, the composition is disposed within the reservoir (102) at atmospheric pressure. In an example of such a non-aerosol reservoir (102), the dispensing device (510) includes a pump, which draws the composition out of the reservoir (102) through a tube via a suction force generated by the pump. To activate the dispensing device (510), the container (100) may include an actuating device. In one example, the actuating device activates the dispensing device (510) to draw the composition to the dispensing device (510), wherein the composition mixes with oxygen to form a foam upon ejection of the composition from the composition container (100).

While specific reference is made to specific dispensing devices (510) and actuating devices, any type of dispensing device (510) may be used. For example, a dispensing device (510) may include any opening and dispensing mechanism, and the actuating device may be any device that draws the composition through the dispensing device (510). In these examples, the dispensing device (510) may include other components such as a valve, a drip tube, and a piston and holding chamber, among other components to aid in the ejection of the composition from the reservoir (102).

As depicted in FIG. 5, the protrusion (104) may extend from a surface of the reservoir (102) that is opposite the dispensing device (510). In this fashion, the composition container (100) is disposed in an upright position to facilitate use of the composition container (100).

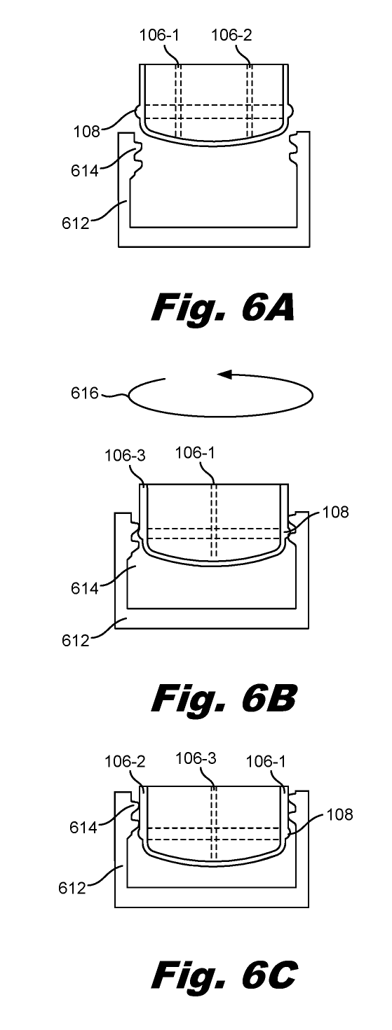

FIGS. 6A-6C are cross-sectional views of the insertion of the bracket interfacing protrusion (104) into a retaining bracket (612), according to an example of the principles described herein. More specifically, as noted above, the horizontal ring (108) and vertical tabs (106) interface with threading (614) on the retaining bracket (612) to facilitate insertion of the composition container (FIG. 1, 100) into the bracket (612). That is, the retaining bracket (612) includes internal threading (614) that engages with the vertical ribs (106) and horizontal rings (108) to draw the composition container (FIG. 1, 100) into the retaining bracket (612). The dashed lines in FIGS. 6A-6C indicate that a component is on a rear surface of the protrusion (104).

The retaining bracket (612) may take any shape or size and interfaces with the horizontal rings (108) and vertical ribs (106) on the protrusion (104). The retaining bracket (612) may be affixed to another surface. For example, in an airplane, the retaining bracket (612) may be affixed to a countertop or a wall near a sink of a restroom to facilitate an occupant washing his/her hands. FIGS. 6A-6C depict various stages of insertion of the composition container (FIG. 1, 100) into the threaded retaining bracket (612).

As depicted in FIG. 6A, the protrusion (104) is not yet inserted into the retaining bracket (612). Upon insertion into the retaining bracket (612), a downward torsional force is applied to the composition container (FIG. 1, 100) as indicated by the arrow (616) in FIG. 6B. In so doing, the bracket interface, i.e., the horizontal rings (108) and vertical ribs (106) engage with the threading (614), which threading (614) being in a helical pattern, draws, the composition container (FIG. 1, 100) downward towards insertion into the retaining bracket (612). Note that as mentioned above, the interface between the threading (614) and the horizontal ring (108) and vertical ribs (106) may be a friction fit such that the protrusion (104), horizontal ring (108), and vertical ribs (106) deform to conform to the shape of the threading.

Once the protrusion (104) “bottoms out,” meaning the horizontal ring (108) is past the threading (614) of the bracket (612) as depicted in FIG. 6C, the vertical ribs (106) maintain a friction fit and the composition container (FIG. 1, 100) is still retained firmly within the retaining bracket (612) while allowing the composition container (FIG. 1, 100) to rotate. In other words, the horizontal rings (108) may be positioned away from the bottom surface of the reservoir (FIG. 1, 102) a distance that is greater than the length of the threading (614) of the retaining bracket (612). In other words, when the bottom surface of the reservoir (FIG. 1, 102) is touching a top surface of the retaining bracket (612), the horizontal ring (108) is below the threading (614) as depicted in FIG. 6C so as to reduce the friction between the composition container (FIG. 1, 100) and the retaining bracket (612). This reduced friction allows a user to rotate the composition container (FIG. 1, 100). In this scenario, there is still sufficient friction via the vertical ribs (106) interfacing with the threading (614) such that the composition container (FIG. 1, 100) will not freely rotate, but is rotatable via user manipulation.

In other words, as the composition container (FIG. 1, 100) is being screwed into a retaining bracket (612), there is a first level of friction due to the interference between 1) the horizontal rings (108) and 2) the vertical ribs (106) with the threading (614). Upon full insertion, there is a second level of friction. The second level of friction is less than the first level of friction due to the removal of the interference between the horizontal ring (108) and the threading (614), as the horizontal ring (108) is a distance removed from the bottom surface of the reservoir (102) that is greater than the length of the threading (614). The first level of friction facilitates engagement of the horizontal ring (108) and the vertical ribs (106) with the threading (614) and the second level of friction facilitates retention of the composition container (FIG. 1, 100) in the retaining bracket (612) while allowing rotation of the composition container (FIG. 1, 100) due to user manipulation.

In summary, the present specification describes a composition container (FIG. 1, 100) with a protrusion (104) that interfaces with threading (614) in a retaining bracket (612). Horizontal rings (108) and vertical ribs (106) on the protrusion (104) interface with the threading (614) on the retaining bracket (612) to draw the composition container (FIG. 1, 100) into the retaining bracket (612). Upon full insertion, the horizontal ring (108) is below the threading (614) thus reducing the overall friction between the protrusion (104) and the retaining bracket (612) such that the composition container (FIG. 1, 100) may be aligned to any orientation. Such a device thus provides secure coupling of a composition container (FIG. 1, 100) to a surface while allowing infinite number of alignment positions.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims and their legal equivalents.

What is claimed is:

1. A composition container comprising:
a reservoir to contain a composition;
a protrusion extending from a surface of the reservoir to interface with a retaining bracket, wherein the protrusion comprises:
a number of vertical ribs extending from a surface of the protrusion; and
a number of horizontal rings extending from the surface of the protrusion.

2. The composition container of claim 1, wherein the composition is a foaming fluid.

3. The composition container of claim 1, wherein the number of vertical ribs and the number of horizontal rings engage with internal threading on the retaining bracket.

4. The composition container of claim 1, wherein the number of horizontal rings are positioned a distance away from the surface of the reservoir greater than a length of threading of the retaining bracket.

5. The composition container of claim 4, wherein the number of horizontal rings, when below the threading of the retaining bracket, allow the composition container to rotate within the retaining bracket.

6. The composition container of claim 1, wherein the protrusion is hollow.

7. The composition container of claim 1, wherein the container is an asymmetrical container.

8. The composition container of claim 1, wherein the protrusion is formed of a softer material than the retaining bracket.

9. The composition container of claim 1, wherein the protrusion is cylindrical.

10. A composition containing system comprising:
a reservoir to contain a composition;
a bracket interface to retain the reservoir in a threaded retaining bracket, wherein the bracket interface comprises at least one horizontal ring and multiple vertical ribs to frictionally couple the reservoir to the threaded retaining bracket.

11. The system of claim 10, wherein the bracket interface is disposed on a protrusion extending below the reservoir.

12. The system of claim 11, wherein the multiple vertical ribs are radially disposed around the protrusion.

13. The system of claim 10, wherein the bracket interface facilitates a friction fit of the reservoir into the threaded retaining bracket.

14. The system of claim 10, wherein the bracket interface engages the threaded retaining bracket when a torsional force is applied.

15. A composition container comprising:
a reservoir to contain a composition;
a dispensing device to dispense the composition from the reservoir onto an application surface; and
a protrusion extending from a surface of the reservoir to interface with, and retain the container to, a retaining bracket, wherein the protrusion comprises a number of radially-disposed vertical ribs extending from a surface of the protrusion and a number of circumferential rings extending from the surface of the protrusion to engage with threads of a threaded retaining bracket to secure the composition container to the threaded retaining bracket.

16. The composition container of claim 15, wherein the protrusion is deformable against threads of the threaded retaining bracket.

17. The composition container of claim 15, wherein the number of horizontal rings are positioned a distance away from the surface of the reservoir greater than the length of threading of the threaded retaining bracket.

18. The composition container of claim 17, wherein the number of horizontal rings, when below the threading of the retaining bracket, allow the composition container to rotate within the retaining bracket.

19. The composition container of claim 15, wherein the protrusion is hollow and is in fluid communication with the reservoir.

20. The composition container of claim 15, wherein the protrusion extends from a surface of the reservoir opposite the dispensing device.
